(19) United States
(12) Patent Application Publication
(10) Pub. No.: US 2008/0252746 A1
(43) Pub. Date: Oct. 16, 2008

(54) METHOD AND APPARATUS FOR A HYBRID WIDE AREA TRACKING SYSTEM

(76) Inventor: Newton Eliot Mack, Somerville, MA (US)

Correspondence Address: BROWN RUDNICK LLP, ONE FINANCIAL CENTER, BOSTON, MA, 02111, US

(21) Appl. No.: 12/102,258

(22) Filed: Apr. 14, 2008

Related U.S. Application Data
(60) Provisional application No. 60/923,210, filed on Apr. 13, 2007.

(51) Int. Cl. H04N 5/228

(52) U.S. Cl. 348/222.1; 348/E05.031

(57) ABSTRACT

An image producing system including at least one scene camera viewing a first image within a defined space, a processor connected to the at least one scene camera, a wide area tracking sensor positioned proximate the defined space, but positioned outside a view of the scene camera, said wide area tracking sensor, coupled to the scene camera, oriented to view at least a portion of the identifying indicia, and a high precision local angular sensor, coupled to the scene camera.

### INCORPORATE BY REFERENCE

This patent application hereby incorporates by reference the Provisional Patent Application No. 60/923,210 filed on Apr. 13, 2007, titled “Method and Apparatus for a Hybrid Wide Area Tracking System”.

### FIELD OF THE INVENTION

The present invention relates to image production, more specifically, to a virtual scene production with 3D spatial positioning.

### BACKGROUND OF THE INVENTION

To generate convincing visual effects composites, the position and orientation of the scene camera should be known. Several methods have been used to derive this information, but two general techniques have been pursued.

The most straightforward technique is to use optical encoders to measure the rotation angle of shafts to which the camera is connected. The most common camera orientation changes are about the vertical and horizontal camera axes, called the pan and tilt axes. Several companies have created encoded camera support mounts that provide pan and tilt information to a computer. The use of encoders with precision machined gears, or other measurement methods that measure the angle between two connected parts, provides a highly accurate measurement of angular camera motion that is sufficient to match a live action foreground and a computer generated background convincingly. The accuracy required is generally at least a tenth of a degree. However, most cinematographers working in dramatic productions prefer not to be restricted to pan and tilt motion of the camera, and thus this has met with limited market acceptance.

### SUMMARY OF THE INVENTION

Various embodiments of a hybrid wide area tracking system are provided. In one embodiment, an image producing system includes at least one scene camera that views a first image within a defined space. The system also includes a processor connected to at least one scene camera. The wide area tracking sensor is positioned proximate the defined space, but positioned outside a view of the scene camera and coupled to the scene camera. The system also includes a high precision local angular sensor coupled to the scene camera. Data from the wide area tracking sensor is combined with data from the high precision local angular sensor.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 depicts a perspective view of a studio with a scene camera positioned to photograph a subject in front of a background in accordance with an embodiment of the present invention.

### DETAILED DESCRIPTION

In the field of virtual scene production, several attempts have been made to expand the use of precision encoded devices to machines that enable a larger area of motion. The difficulty and expense in making a mechanical device that is both large and precise has thus far prevented this from becoming commonly used in the video and film production industries.

In order to attempt to allow the type of large camera motions that are considered aesthetically pleasing, many different types of wide area tracking devices have been invented over the years. Among the non-contact technologies that have been tried are optical pattern recognition, inertial sensing, and acoustic time of flight signal calculation. All of these have failed in the marketplace due to a combination of factors. One of the most significant factors is that the match between the foreground and the background has not been sufficiently accurate to generate a convincing composite.

Due to the nature of optics, the level of accuracy needed for a positional match versus an orientation match is quite different. When the camera moves back and forth, while the orientation remains fixed, a 1 mm lateral error in the camera position tracking will result in a 1 mm lateral error in the computer generated background position. Generally, this error is small enough to go unnoticed. However, when the camera is rotated, as during a pan or tilt move, a small angular error at the camera source is magnified by the distance between the camera and the subject. The net result is that orientation measurement errors are far more visible than positional measurement errors.

The various types of wide area tracking devices have generally relied upon a single technology to generate both the position and orientation information. Thus, they have similar levels of error in the position and orientation measurements. The problem is that while the positional error may be sufficient, the orientation error is higher than the tenth of a degree threshold, and results in very visible mismatches between the foreground and background. There have been wide area tracking devices that were sufficiently precise enough to generate accurate position and orientation information, but the cost of driving both the positional and angular measurement accuracy high enough, using the same technology for both, has proved cost prohibitive and the devices have not been a market success. The present invention provides a cost effective, reliable system for producing a camera position and orientation data stream with sufficient accuracy to combine live video with other imagery, including computer generated imagery, in an accurate and convincing manner. The present invention provides a seamless environment expanding the capabilities of virtual video production. Applications ranging from video games to feature films can implement the system for a fraction of the cost of traditional virtual sets. The system greatly reduces the costly and complex computer processing time required in existing systems. The present invention enables smooth tracking of camera moves typically used in motion picture and television photography.

The proposed invention uses a hybrid approach. Using a combination of a relatively inaccurate wide area positional tracking system and an accurate pan and tilt angular sensor to derive the camera's orientation, it is possible to use the type of sensor most suited to each level of tracking accuracy. However, the data from the devices must be fused properly to generate an easy to use system that will not confuse the intended users of the devices.

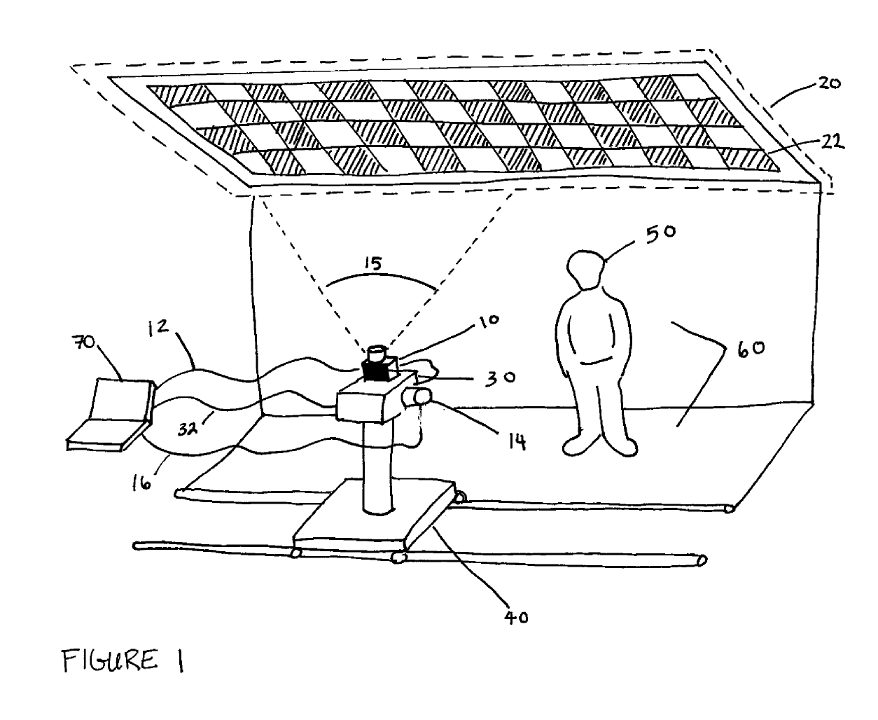

The present invention uses a combination of a high precision local angular measurement with a lower precision global position and orientation measurement. An embodiment of the present invention is illustrated in FIG. 1. A scene camera 30 is positioned to capture an image of a subject 50 in front of a background 60. The scene camera 30 is typically mounted on a camera support 40. This camera support 40 may be in the form of a tripod, dolly, jib arm, or many other forms of camera support in common use. There may be more than one scene camera 30 in order to capture different views of the subject's performance. The scene camera 30 is connected to a computer 70 by a scene camera data cable 32, however other means of connecting may be used. A wide area tracking sensor camera 10 is attached to the scene camera 30 and oriented so that some or all of a tracking marker pattern 20 is within its field of view 15. An encoded pan and tilt sensor 14 is attached to the scene camera 30. A data cable 16 connects the pan and tilt sensor 14 to the computer 70. The computer 70 may be positioned near the scene camera 30 so that the camera operator and/or the director can see the system output.

The tracking marker pattern 20 in one embodiment is a flat panel with a printed pattern facing downward. The printed pattern includes several individual tracking markers 22. The tracking marker pattern 20 is advantageous as it is easily portable and can be installed quickly in a variety of locations. The tracking camera 10 is connected to the computer 70 by a tracking camera data cable 12. The tracking camera 10 and scene camera 30 may also be connected to separate computers 70 that communicate with each other through a network (wired or wireless). Although this embodiment describes the use of a tracking marker pattern, one skilled in the art should recognize that a tracking marker pattern is not required. The present invention may be implemented without deviating from the scope of the invention without the use of a tracking marker pattern.

Although the present embodiment depicted describes a data cable as the means of connecting the cameras to the processors, one skilled in the art should recognize that any form of data transmission may be implemented without deviating from the scope of the invention.

In addition, although the present embodiment depicts the use of an encoder for high precision angular measurement using the encoded pan and tilt sensor, one skilled in the art should recognize that any other means may be used for the high precision angular measurement. For example, a potentiometer is an example of a high precision angular measurement device that may be used with the system of the present invention.

The tracking camera 10 collects images of the tracking marker pattern 20. The image quality needed for tracking the tracking marker 10 is lower than the image quality generally needed for the scene camera 30, enabling the use of a lower cost tracking camera 10. In one embodiment, the tracking camera 10 is a simple electronic camera with a fixed field of view 15. Since the tracking camera 10 is not focused upon the scene, the tracking performance is independent of the exact contents and lighting of the subjects 50 in the scene. The present implementation of a separate tracking camera 10, as shown in the present embodiment, eliminates the need for special background materials and complex set preparation.

The raw data collected from tracking camera 10 provides a global orientation value that is accurate. The accuracy may range between 0.2 and 0.8 degrees, and more specifically within approximately 0.5 degree. As the requirement for a convincing match between the live action foreground and the synthetic background is an accuracy range approximately between 0 and 0.3 degrees and more specifically within approximately 0.1 degree. The data from the tracking camera is combined with the data from the encoded pan and tilt sensor. The heightened angular accuracy requirement may be needed when the camera is actively being panned or tilted, otherwise the overall global orientation information may be used. To achieve this, the fusion algorithm has both calibration information and current angular information.

The calibration information for the present embodiment includes the encoder counts per degree of pan or tilt motion, and an original encoder count paired with an original global orientation. Since the high accuracy pan/tilt sensor is not generally capable of global sensing, its measurements may be correlated with the overall global position sensor.

The current angular information includes the present encoder count for each axis, and the present global orientation angle. The mathematics used for any high precision local sensor is substantially similar to the algorithm shown below. To avoid a complicated calibration step, the algorithm used is as follows.

```
Variables Used:
countsPerDegree = encoder counts per degree of rotation
globalEncoderCalibrationCount = encoder value at global calibration
point
globalEncoderCalibrationDegree = global angle measurement at
calibration point
currentEncoderCount = current encoder count
currentGlobalAngle = current global angle from wide area sensor
encoderDifference = difference between present encoder count and global
encoder calibration count
deltaEncoderCount = difference between previous/current encoder
measurement
deltaGlobalAngle = difference between previous/current global angular
value
allowedError = difference allowed between global and local angles
before forcing recalibration; 3 degrees in preferred embodiment
outputAngle = final angle determined by algorithm
Algorithm:
derivedEncoderAngle = globalEncoderCalibrationDegree +
encoderDifference/countsPerDegree;
angularDisparity = abs(derivedEncoderAngle − currentGlobalAngle);
if ((deltaEncoderCount !=0) && (deltaGlobalAngle !=0)
{
    if (angularDisparity < allowedError)
        outputAngle = derivedEncoderAngle;
    else
    {
        globalEncoderCalibrationCount = currentEncoderCount;
        globalEncoderCalibrationDegree = currentGlobalAngle;
        outputAngle = currentGlobalAngle;
    }
}
```

The algorithm noted above may determine the current angular measurement predicted by the encoder position, and may calculate the disparity between the encoder derived angle and the present globally measured angle. The algorithm also may determine if both the global angular sensor and the local encoded angular sensor are moving.

If the angular disparity is less than the allowable error, the algorithm determines that the encoder based angular value is the correct value and assigns it to the output angular value. In one embodiment, the allowable error is 3 degrees, but the allowable error may vary dependent on several variables.

If the disparity is greater than the allowable error, the global encoder calibration count is set to the current calibration count, and the global calibration angle is set to the current global angle. The current global measurement angle is assigned to the output angle.

The most accurate angular measurement is used for calculating the majority of the angular motion, while staying synchronized with the global orientation measurement. The encoders will automatically calibrate themselves to the global camera orientation as soon as the camera is placed upon the encoded sensor and moved.

In addition, this algorithm serves as a very effective noise reduction algorithm. The angular sensors used to generate global orientation values generally have a high degree of angular noise, which if left unfiltered will cause the synthetic background to exhibit a very visible ‘shake’ when the camera is stationary. The abilities of both sensor types are used to their fullest advantage.

In one embodiment, a scene camera records the image of a subject in front of a background. The scene camera is connected to a computer or recorder by a data cable or wireless data link. A tracking camera facing upwards or downwards is mounted to the scene camera, and is also connected to a computer, either the same computer or another computer on a network, by a data cable. A pattern of optical markers that may be seen by the tracking camera is located either overhead or on the floor. The markers are affixed to an overhead panel in this embodiment. The images of the tracking marker are also sent to a computer, which calculates the scene camera's position and orientation based on the position of the markers overhead. If the scene camera moves during recording, the tracking camera will process its location by the tracking marker motion and the images provided by the computer may be adjusted accordingly. In addition, an encoded pan and tilt sensor is used to attach the camera to the camera support, to provide highly accurate angular motion data.

The computer, using a three-dimensional graphics engine, will superimpose a computer-generated image or images into the live recording image from the camera. The graphics engine processes the location of the scene camera in combination with the data of the computer generated image to adjust for factors such as proper depth, field of view, position, resolution, and orientation. The adjusted virtual images or background are combined with the live recording to form a composite layered scene of live action and computer generated graphics.

In addition to the description of specific, non-limited examples of embodiments of the invention provided herein, it should be appreciated that the invention may be implemented in numerous other applications involving the different configurations of video-processing equipment. Although the invention is described hereinbefore with respect to illustrative embodiments thereof, it will be appreciated that the foregoing and various other changes, omissions and additions in the form and detail thereof may be made without departing from the spirit and scope of the invention.

What is claimed is:

1. An image producing system, the system comprising:
at least one scene camera viewing a first image within a defined space;
a processor connected to said at least one scene camera;
a wide area tracking sensor positioned proximate said defined space, but positioned outside a view of said scene camera, wherein said wide area tracking sensor is coupled to said scene camera; and
a high precision local angular sensor, coupled to said scene camera, wherein data from said wide area tracking sensor is combined with data from said high precision local angular sensor.

2. The system of claim 1, wherein said scene camera is mounted upon a camera support.

3. The system of claim 2, wherein said camera support may be a tripod, dolly, jib arm, or other form of camera support.

4. The system of claim 1, wherein said processor is connected to said at least one scene camera by a scene camera data cable.

5. The system of claim 1, wherein said processor is connected to said high precision local angular sensor.

6. The system of claim 1, wherein said wide area tracking sensor includes a tracking marker pattern.

7. The system of claim 6, wherein said tracking marker pattern is a flat panel with a printed pattern facing downwards or upwards.

8. The system of claim 1, wherein said wide area tracking sensor is connected to said processor by a data cable.

9. The system of claim 1, wherein said high precision local angular sensor is used to derive an orientation for said scene camera.

10. The system of claim 1, wherein said high precision local angular sensor provides accuracy for said system.

11. The system of claim 1, wherein said wide area tracking sensor is a tracking camera.

12. The system of claim 1, wherein said high precision local angular sensor is an encoded pan and tilt sensor.

13. A method for producing images, the method comprising:
viewing a first image using at least one scene camera within a defined space;
obtaining said first image;
processing said first image;
positioning a wide area tracking sensor proximate said defined space, but positioned outside a view of said scene camera, wherein said wide area tracking sensor is coupled to said scene camera;
coupling said scene camera to a high precision local angular sensor; and
combining data from said wide area tracking sensor with data from said high precision local angular sensor to provide said images.

14. The method of claim 14, wherein said scene camera is mounted upon a camera support and wherein said camera support may be a tripod, dolly, jib arm, or other form of camera support.

15. The method of claim 13, wherein said processor is connected to said at least one scene camera by a scene camera data cable.

16. The method of claim 13 wherein said wide area tracking sensor includes a tracking marker pattern.

17. The method of claim 16, wherein said tracking marker pattern is a flat panel with a printed pattern facing downwards or upwards.

18. The method of claim 13, wherein said high precision local angular sensor is used to derive an orientation for said scene camera.

19. The method of claim 13, wherein said wide area tracking sensor is a tracking camera.

20. The method of claim 13, wherein said high precision local angular sensor is an encoded pan and tilt sensor.
